(19) United States
(12) Patent Application Publication
(10) Pub. No.: US 2024/0330433 A1
(43) Pub. Date: Oct. 3, 2024

(54) AUTOMATED VALIDATION OF APPLICATION STACKS

(71) Applicant: Oracle International Corporation, Redwood Shores, CA (US)

(72) Inventor: Rajeev Agrawal, Bothell, WA (US)

(73) Assignee: Oracle International Corporation, Redwood Shores, CA (US)

(21) Appl. No.: 18/128,485

(22) Filed: Mar. 30, 2023

(51) Int. Cl. G06F 21/52; G06Q 10/0631

(52) U.S. Cl. CPC G06F 21/52; G06Q 10/06311; G06F 2221/033

(57) ABSTRACT

Systems and methods for automated validation of application stacks are described herein. A method for automated validation of application stacks can include receiving identification of a stack for validation at a publication service system from a customer tenancy in a cloud computing environment. The stack can include an associated stack identifier. The method can include retrieving with the publication service system job information from the customer tenancy relevant to the stack and determining validation status of the stack based on the retrieved job information. The method can include designating the stack as a valid stack when it is determined that the stack is valid.

### BACKGROUND

The present application relates to cloud computing. Cloud computing can provide on-demand availability of computing resources without direct active management by a user. Infrastructure as a service (IaaS) is a type of cloud computing service. IaaS can include one or several tenancies, each of which can be a private or public environment that can be isolated from each other. Thus, an action taken in one tenancy may not affect another tenancy. While cloud computing provides many benefits, further improvements are desired.

### BRIEF SUMMARY

One aspect of the present disclosure relates to a method for automated validation of application stacks. The method can include receiving at a publication service system identification of a stack for validation from a customer tenancy in a cloud computing environment. In some embodiments, the stack can have an associated stack identifier. The method can include retrieving with the publication service system job information from the customer tenancy relevant to the stack, determining validation status of the stack based on the retrieved job information, and designating the stack as a valid stack when it is determined that the stack is valid.

In some embodiments, the method can includes receiving in the cloud computing environment policies allowing access of the customer tenancy by the publication service system. In some embodiments, the policies allowing access of the customer tenancy by the publication service system allows the publication service system to read at least one of: tenant in the customer tenancy; compartments in the customer tenancy; stacks in the customer tenancy; or jobs in the customer tenancy.

In some embodiments, the method can include receiving a stack in the customer tenancy. In some embodiments, the stack is received in the customer tenancy by uploading the stack to the customer tenancy. In some embodiments, the method can include testing the stack in the customer tenancy by performing a plurality of jobs, and storing job information in the customer tenancy and associated with the stack. In some embodiments, the plurality of jobs can include at least one of: PLAN; APPLY; or DESTROY.

In some embodiments, receiving identification of the stack can include receiving an artifact. In some embodiments, retrieving job information from the customer tenancy relevant to the stack can include accessing with the publication service system the customer tenancy. In some embodiments, retrievingjob information from the customer tenancy relevant to the stack can include querying the customer tenancy for a list of jobs associated with the stack. In some embodiments, at least some of the jobs associated with the task correspond to validation tests and include at least one of: APPLY; or DESTROY. In some embodiments, determining validation status of the stack based on the retrieved job information can include: identifying the latest one or more jobs with operation APPLY or DESTROY; and determining the lifecycle-state of the latest one or more jobs with operation APPLY or DESTROY.

In some embodiments, it is determined that the stack is valid when the latest one or more jobs with operation APPLY or DESTROY have a lifecycle-state of succeeded. In some embodiments, the method includes downloading the stack to the publication service system, and scanning the stack for viruses. In some embodiments, the method includes receiving a request from the customer tenancy to publish the stack. In some embodiments, the method includes publishing the stack. In some embodiments, the stack can be a terraform stack.

One aspect relates to a system for automated validation of application stacks. The system can include a memory containing stored instructions and a processor that can execute the stored instructions. The processor can be configured to execute the stored instructions to receive at a publication service system identification of a stack for validation from a customer tenancy in a cloud computing environment, retrieve with the publication service system job information from the customer tenancy relevant to the stack, determine validation status of the stack based on the retrieved job information, and designate the stack as a valid stack when it is determined that the stack is valid. In some embodiments, the stack can have an associated stack identifier.

In some embodiments, the processor can be further configured to execute the stored instructions to receive in the cloud computing environment policies allowing access of the customer tenancy by the publication service system, receive a stack in the customer tenancy, test the stack in the customer tenancy by performing a plurality of jobs, and store job information in the customer tenancy and associated with the stack.

One aspect relates to a non-transitory computer-readable storage medium storing a plurality of instructions executable by one or more processors. The plurality of instructions when executed by the one or more processors cause the one or more processors to receive at a publication service system identification of a stack for validation from a customer tenancy in a cloud computing environment, retrieve with the publication service system job information from the customer tenancy relevant to the stack, determine validation status of the stack based on the retrieved job information, and designate the stack as a valid stack when it is determined that the stack is valid. In some embodiments, the stack can have an associated stack identifier.

### BRIEF DESCRIPTION OF THE DRAWINGS

FIG. 1 is a schematic depiction of one embodiment of a system for automated validation of a stack.

FIG. 2 is a flowchart illustrating one embodiment of a process for automated validation of an application stack.

FIG. 3 is depiction of one embodiment of a stack selection interface.

FIG. 4 is a flowchart illustrating one embodiment of a process performed by a partner portal and/or publisher service system for automated validation of an application stack.

FIG. 5 is a block diagram illustrating one pattern for implementing a cloud infrastructure as a service system, according to at least one embodiment.

FIG. 6 is a block diagram illustrating another pattern for implementing a cloud infrastructure as a service system, according to at least one embodiment.

FIG. 7 is a block diagram illustrating another pattern for implementing a cloud infrastructure as a service system, according to at least one embodiment.

FIG. 8 is a block diagram illustrating another pattern for implementing a cloud infrastructure as a service system, according to at least one embodiment.

FIG. 9 is a block diagram illustrating an example computer system, according to at least one embodiment.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

A cloud services provider (such as Oracle Corporation of Redwood Shores, California) may provide one or more cloud services that can be subscribed to by customers (or subscribers) of the offered services. Customers can have one or more customer tenancies, each of which can be a private or public environment that can be isolated from each other. Thus, an action taken in one tenancy may not affect another tenancy.

A Digital Content Distribution Forum (DCDF), also referred to herein as a digital marketplace, can distribute software that can include images and stack listings. Images and stacks can include different categories of applications. For example, an image can be a template of a virtual hard drive that determines the operating system and software to run on an instance. An image listing can be deployed in an instance. In contrast, a stack can represent definitions of a group of resources that can be acted on as a group. A stack can include a configuration that can include one or more declarative configuration files.

The DCDF can be provided by a cloud services provider. The DCDF can include image listings and stack listings generated by the cloud services provider, or generated by a third party, also referred to herein as a DCDF partner. In some embodiments, each of the image listings and stack listings can include an identifier. This identifier can be a unique identifier assigned by the cloud services provider.

It can be difficult to manually test/validate stacks submitted by DCDF partners for distribution via the DCDF. These difficulties can arise due to the complexity of such stacks, and also due to the potential dependency of at least portions of some or all of the stacks on external infrastructure. As a result, a DCDF may only perform minimal testing on stacks submitted by DCDF partners. Further, even though this testing may be minimal, this testing may still require significant amounts of time and/or resources to complete.

Embodiments disclosed herein relate to the automated validation of stacks. These stacks can be stacks submitted by, for example, DCDF partners. In some embodiments, the DCDF can operate in a cloud computing environment, and the DCDF partner can have a tenancy in the cloud computing environment. The stack can be received in the DCDF partner's tenancy. In some embodiments, the stack can be received in the DCDF partner's stack by the creation of that stack in the DCDF partner's tenancy or by the uploading of that stack to the DCDF partner's tenancy. The stack can be a terraform stack. The DCDF partner can provide and/or update tenancy policies to allow access of the DCDF partner's tenancy by a partner portal and/or by a publication service system.

The DCDF partner can test the stack in their tenancy and/or on a local device, and can save the results of the testing in their tenancy. This testing can include the performing of one or several jobs, which jobs can include “PLAN,” “APPLY,” and/or “DESTROY.” In some embodiments, the job “PLAN” in a terraform stack can preview action taken by the terraform stack to modify computing infrastructure. Specifically, this can include generating an execution plan that shows actions to be taking by terraform to achieve a desired infrastructure place. In some embodiments, this can include comparing the current state of the infrastructure with the desired state defined in the Terraform configuration files and showing the differences between those states. In some embodiments, the “PLAN” command does not make any changes to the infrastructure. In some embodiments, the job “APPLY” in a terraform stack can execute actions proposed and/or defined in the terraform plan, and can apply the desired state to the infrastructure. In some embodiments, the “APPLY” command can create, modify, or delete resources as needed to bring the infrastructure to the desired state. When executing “APPLY”, the relationship between physical infrastructure object and the terraform configuration is maintained in a state file. In some embodiments, the job “DESTROY” in a terraform stack can terminate resources managed by a current terraform project by deleting infrastructure resources present in the state file. The “DESTROY” command can destroy all of the resources that are defined in the Terraform configuration files. The “DESTROY” command can remove all the resources that were created by Terraform previously. In some embodiments, the outcome of each job can be characterized as either success or failure, and the outcome of each job can be stored in the DCDF partner's tenancy. In some embodiments, the jobs can be performed multiple times, and the results of the repeated jobs can be stored in the DCDF partner's tenancy. In some embodiments, the results of the repeated jobs can be stored in the DCDF partner's tenancy such that the results of the most recent jobs can be identified. Storing the results of the repeated jobs such that the results of the most recent jobs can be identified can include, for example, associating a time stamp with each job result, overwriting previous job results with newer job results, or the like.

When the job results have be stored in the DCDF partner's tenancy, these job results can be accessed by, for example, the partner portal and/or the publication service system. The job results can be evaluated to determine whether to validate the stack. In some embodiments, this evaluation can include determining whether the job results indicate that some or all of the jobs were successfully complete for the stack. In some embodiments, for example, a stack is eligible for validation when it is determined based on the stored testing results that some or all of the jobs “PLAN,” “APPLY,” and “DESTROY” were successfully performed on the stack.

If it is determined that the stack cannot be validated, then the stack is not identified as validated, and the stack is not eligible for publication in the DCDF. If it is determined that the stack can be validated, then the stack can be identified as validated and/or as eligible for publication in the DCDF. The DCDF partner can provide an input selecting the stack for publication. The stack can be downloaded from the DCDF partner's tenancy to, for example, the partner portal and/or to the publication service system. In some embodiments, the stack can be evaluated to determine whether the stack includes any malware and/or viruses. If it is determined that the stack does not contain any malware and/or viruses, then the stack can be published in the DCDF and/or can be made available in the DCDF.

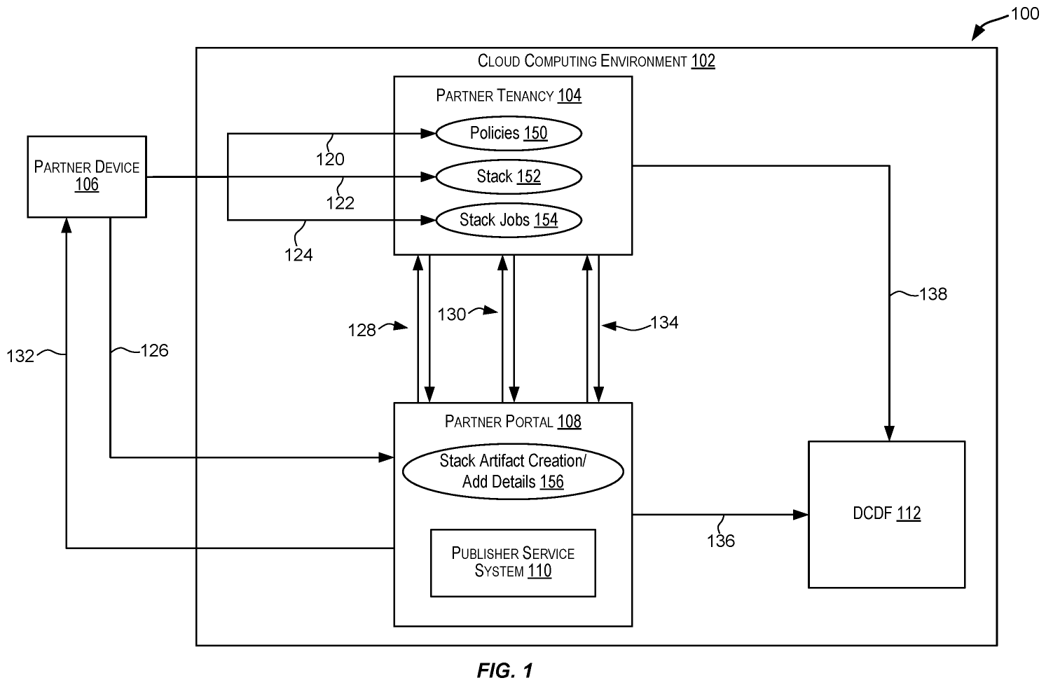

With reference now to FIG. 1, a schematic depiction of one embodiment of a system 100 for automated validation of a stack is shown. The system 100 can include and/or be within a cloud computing environment 102. The cloud computing environment 102 can include one or several tenancies, including the partner tenancy 104, also referred to herein as the DCDF partner tenancy 104. The system 100 can be communicatively coupled to a partner device 106, also referred to herein as a customer device 106, and specifically, the partner tenancy 104 can be communicatively coupled to the partner device 106. The partner device 106 can be a computing device such as, for example, one or several servers, computers, PCs, tablets, smartphones, or the like.

The customer can create a stack in the customer tenancy 104. The creation of this stack can include the authoring of the stack in the customer tenancy 104 and/or the uploading of the stack to the customer tenancy 104. The creation of the stack can further include the identifying of one or several attributes of the stack, including, for example, the region, tenancy, and/or compartment containing the stack. In some embodiments, for example, the stack can be associated with an identifier of the region, and identifier of the tenancy, and/or an identifier of the compartment. In some embodiments, one or several of these identifiers can be automatically associated with the stack, and in some embodiments, the customer can associate one or several of these identifiers with the stack.

The customer can further create and/or update policies in the partner tenancy 104. In some embodiments, these policies can control one or several aspects of accessibility of the tenancy. In some embodiments, for example, this can include, one or several policies to allow a partner portal (discussed below) to access the partner tenancy 104 and retrieve information from the partner tenancy. In some embodiments, information retrieved from the partner tenancy can relate to one or several stacks, and specifically to testing performed on one or several stacks in the partner tenancy 104. In some embodiments, this testing can include performing one or several jobs, and thus the information relating to testing performed on one or several stack in the partner tenancy 104 can include information relating to the performing of the one or several jobs on the stack.

The partner tenancy 104 can be further communicatively coupled to the partner portal 108. The partner portal 108 can be an application through which a customer can create, submit, and manage app and/or service listings that the customer published on the DCDF. The portal 108 can run on the publisher service system 110, which can be the hardware on which the partner portal 108 runs. In some embodiments, the partner portal 108 can receive information from and/or information to the partner tenancy 104.

The system 100 can further include the DCDF 112. The DCDF 112 can be communicatively coupled with one or both of the partner tenancy 104 and the partner portal 108. The DCDF 112 can, in some embodiments, receive and publish stacks.

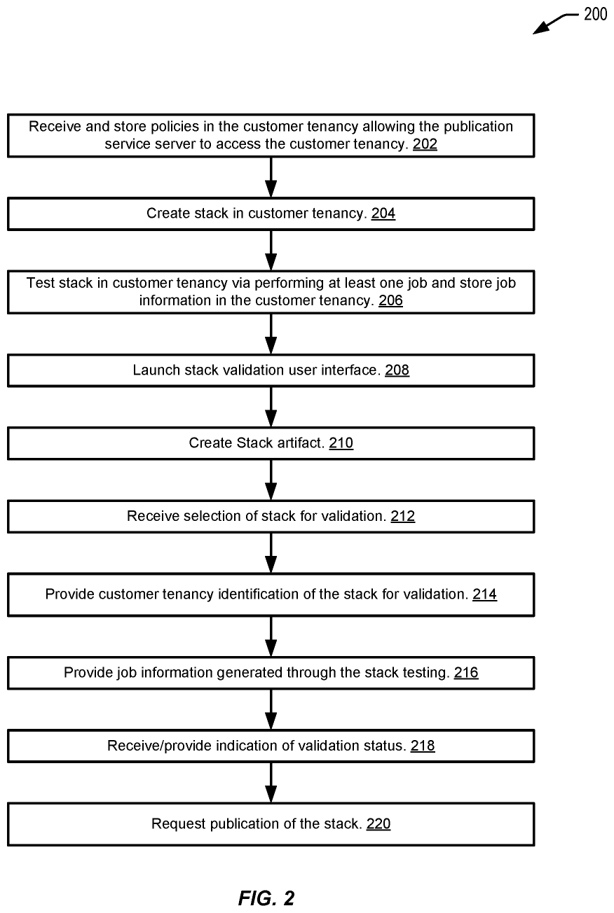

The automated validation of application stacks includes a process performed by and/or in the partner tenancy 104 and/or a process performed by and/or in the partner portal 108. With reference now to FIG. 2, a flowchart illustrating one embodiment of a process 200 for automated validation of an application stack is shown. The process 200 can be performed by all or portions of the system 100, and can specifically be performed by the partner (also referred to herein as the customer) via the partner tenancy 104, also referred to herein as the customer tenancy 104.

The process 200 begins at block 202, wherein the policies are received and stored in the customer tenancy. These policies can be received in the customer tenancy 104 from the partner device 106 as represented by arrow 120 in FIG. 1. In some embodiments, for example, the customer can enter and/or update one or more policies into the partner device 106 via, for example, a graphical user interface. These one or several policies can be provided from the partner device 106 to the partner tenancy 104. In some embodiments, policies 150 that have been received by the partner tenancy 104 can be stored in the partner tenancy 104.

In some embodiments, the receipt of these policies can include the updating of policies previously provided by the user and/or the updating of one or several default policies. In some embodiments, policies can be updated to allow the partner portal 108 and/or the publisher service system 100 to access the partner tenancy 104. In some embodiments, the policies allowing access of the customer tenancy 104 by the publication service system 110 and/or by the partner portal 108 allows the publication service system 110 and/or the partner portal 108 to read at least one of: tenant in the customer tenancy 104; compartments in the customer tenancy 104; stacks in the customer tenancy 104; or jobs in the customer tenancy 104.

In some embodiments, these policies can be updated to allow the partner portal 108 and/or the publisher service system 110 to access information relating to the stack in the partner tenancy 104, and/or in one or several compartments in the partner tenancy 104. In some embodiments, these policies can be updated to allow the partner portal 108 and/or the publisher service system 110 to read stacks in the customer tenancy 104 and/or to read testing results including job results in the customer tenancy 104.

At block 204, the stack is created in the customer tenancy 104. In some embodiments, the creation of the stack in the customer tenancy 104 can include the receiving of the stack 152 in the customer tenancy 104 via, for example uploading of the stack 152 to the customer tenancy 104. In some embodiments, the stack can be created in one or several specific compartments of the customer tenancy 104 and/or in one or several regions associated with the customer tenancy 104. In such an embodiment, the stack 152 can be uploaded to the customer tenancy 104, and specifically to the desired compartment of the customer tenancy 104 and/or to the desired one or several regions associated with the customer tenancy 104.

In some embodiments, the stack 152 can be uploaded to the customer tenancy 104 by the customer via the customer device 106. In some embodiments, the stack 152 can be created by the customer with the customer device 106 and can then be uploaded to the customer tenancy 104, as indicated by arrow 122 in FIG. 1. In some embodiments, the stack 152 can comprise a terraform stack.

At block 206, the stack is tested in the customer tenancy 104. The testing of the stack is indicated in FIG. 1 by arrow 124. In some embodiments in which the stack is in a specific region and/or compartment, the testing can be performed in the specific region and/or compartment, and the information from the completed jobs can be stored in that region and/or compartment, as indicated by stack jobs 154 in FIG. 1.

In some embodiments, testing the stack in the customer tenancy 104 can include performing one or several jobs on the stack, and storing job information from the jobs performed on the stack in the customer tenancy. These jobs can include at least one of: “PLAN;” “APPLY;” or “DESTROY.” In some embodiments, the job “PLAN” in a terraform stack can preview action taken by the terraform stack to modify computing infrastructure. In some embodiments, the job “APPLY” in a terraform stack can execute actions proposed in the terraform plan. When executing “APPLY”, the relationship between physical infrastructure object and the terraform configuration is maintained in a state file. In some embodiments, the job “DESTROY” in a terraform stack can terminate resources managed by a current terraform project by deleting infrastructure resources present in the state file. In some embodiments, the outcome of each job can be characterized as either success or failure, and the outcome of each job can be stored in the DCDF partner's tenancy.

At block 208 the stack validation user interface is launched. In some embodiments, the stack validation user interface can be launched in the partner portal 108.

The stack validation user interface can allow the customer to create an artifact from the stack, as indicated in block 210 and by arrow 126 in FIG. 1. This artifact can be created by the customer device 106 in the partner portal 108. This artifact is shown as 156 in FIG. 1, can comprise a terraform artifact. In some embodiments, and in creating the artifact, the customer can associate one or several identifiers with the artifact. These identifiers can, identify information relating to the tenancy, region, and/or compartment containing the stack. In some embodiments, for example, the customer can associate the artifact with an identifier the tenancy and/or of the compartment containing the stack. This information can be stored with the artifact in the partner portal 108.

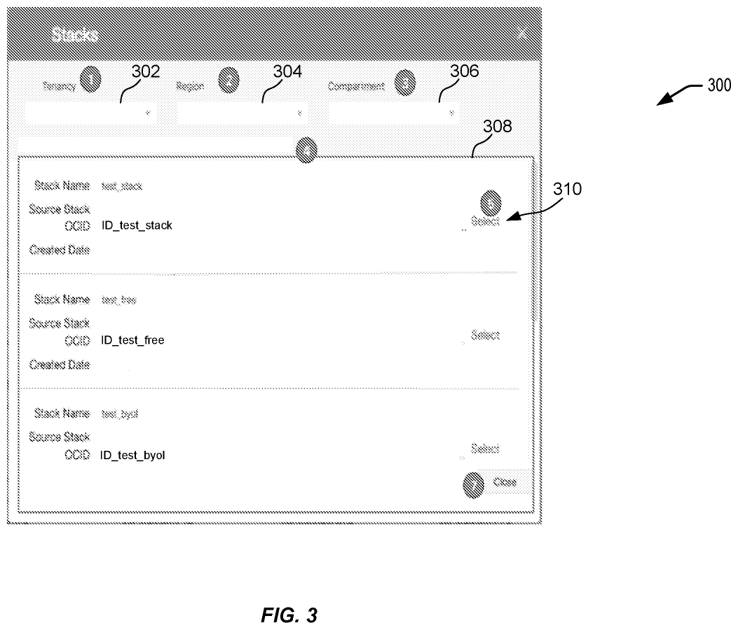

At block 212, a stack selected for validation is received. In some embodiments, this can include the launch of the stack selection interface 300 as shown in FIG. 3. The stack selection interface 300 can be used by the customer in validating the stack, and specifically can be used by the customer to select a stack that can be validated by the partner portal 108 and/or the publisher service system 110.

The stack selection interface 300 can allow the user to select a tenancy via for example tenancy dropdown menu 302, a region via for example region dropdown menu 304, and/or select a compartment via for example compartment dropdown menu 306. After information specifying the location of the stack is received, the stack selection interface 300 displays any stacks in the selected location in the stack window 308. For each displayed stack, a name of the stack and a stack identifier is displayed in the stack window 308. In some embodiments, the stack window 308 can further include, for each stack, a creation date and/or a source stack.

The stack selection interface 300 can further include, for some or all of the displayed stacks, a user manipulable feature 310. The user manipulable feature 310 can comprise, for example, a button such as a text button. In some embodiments, and as depicted in FIG. 3, the user manipulable feature comprises a text button, namely “select.” In some embodiments, manipulation of the user manipulable feature 310 can select the stack associated with the user manipulable feature. In some embodiments, a stack selection can be received via use manipulation of the manipulable feature 310.

At block 214, the customer tenancy 104 provides tenancy identification of the stack selected for validation. In some embodiments, this can include the customer tenancy 104 providing tenancy information to the partner portal 108 and/or to the publisher service system 110 in response to a request from the partner portal for the tenancy information. Both the request for tenancy information and the providing of the tenancy information are depicted with arrows 128 in FIG. 1.

In some embodiments, this tenancy information can include information relating to one or several compartments within the tenancy. This information relating to the tenancy can be provided to the partner portal 108 and/or to the publisher service system 110 according to the policies received in block 202. In some embodiments, and according to the policies received in block 202, the partner portal 108 and/or the publisher service system 110 can access the customer tenancy 104 to retrieve the tenancy information, and specifically to query for the tenancy information and to receive the tenancy information in response to their queries.

At block 216, testing information is provided from the customer tenancy 104 to the partner portal 108. In some embodiments, this testing information can be testing information to the stack selected for validation in block 212. In some embodiments, this can include the customer tenancy 104 providing testing information to the partner portal 108 and/or to the publisher service system 110 in response to a request from the partner portal 108 and/or from the publisher service system 110 for the tenancy information. Both the request for testing information and the providing of the testing information are depicted with arrows 130 in FIG. 1.

In some embodiments, the testing information can include information relating to one or several tests performed on the selected stack. This can include the performing of one or several jobs on the selected stack. Thus, in some embodiments, the testing information provided in block 216 can be job information generated through the testing of the selected stack. This information can identify which jobs were performed and whether the jobs were successfully or unsuccessfully completed. This information relating to the testing of the selected stack can be provided to the partner portal 109 and/or to the publisher service system 100 according to the policies received in block 202. In some embodiments, and according to the policies received in block 202, the partner portal 108 and/or the publisher service system 110 can access the customer tenancy 104 to retrieve the testing information, and specifically to query for the testing information and to receive the testing information in response to their queries.

At block 218, the customer receives an indication of validation status. This indication of validation status can be provided to the customer via the partner portal 108 as indicated with arrow 132 of FIG. 1. In some embodiments, and after determining the validation status of the selected stack, the partner portal 108 can provide an indication of validation status to the customer, and specifically to the customer device 106 and/or to the customer tenancy 104. In some embodiments, this can include adding the selected stack to a list of validated stacks when it is determined that the stack is validated, or adding the selected stack to a list of non-validated stacks when it is determined that the stack is not validated. In some embodiments, providing the indication of validation status can include associating a first value with the selected stack when it is determined that the selected stack is validated, and associated a second value with the second stack when it is determined that the selected stack is not validated.

In some embodiments, in response to receipt of an indication of the stack being validated, the selected and now validated stack can be identified in a list of validated stacks to the user. In some embodiments, and as indicated in block 220, the customer can select the now validated stack for publication to the DCDF 112.

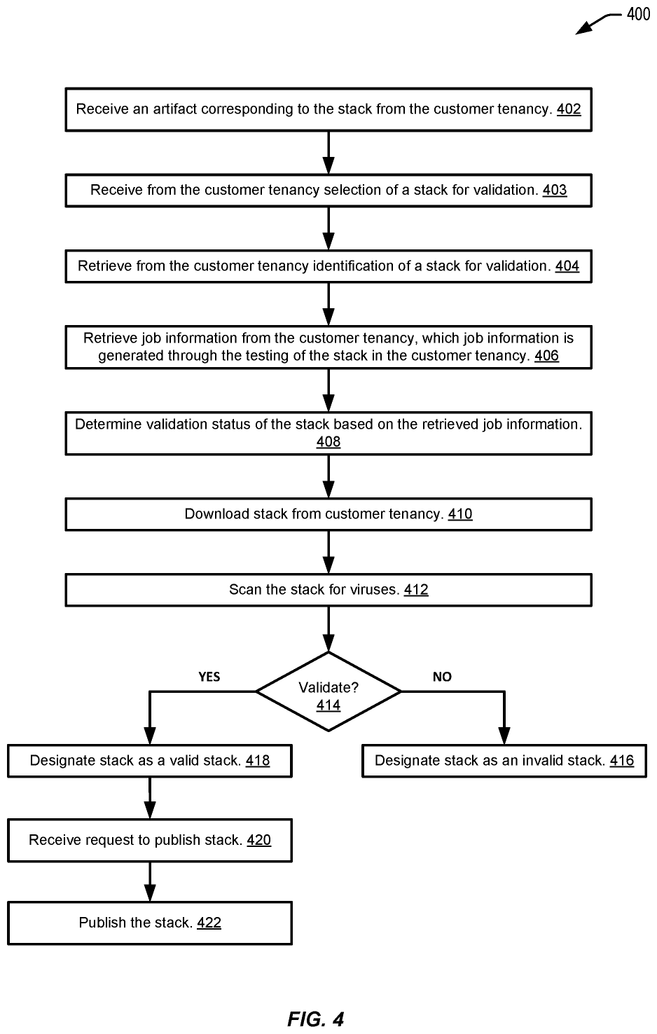

With reference now to FIG. 4, a flowchart illustrating one embodiment of a process 400 for automated validation of an application stack is shown. The process 400 can be performed by all or portions of the system 100, and can specifically be performed by the partner portal 108 and/or by the publisher service system 110. In some embodiments, the process 400 can be performed in concert with the process 200. Thus, some of the steps of process 400 can be performed in response to some of the steps of process 200. In some embodiments, process 200 and process 400 can be performed such that some of the steps of these processes 200, 400 are performed simultaneously and/or subsequently to each other. In some embodiments, some of the steps of process 200 can lead to the initiation of the steps of process 400. Specifically, in some embodiments, for example, the performing of step 210 of process 200 can lead to the initiation of process 400.

The process 400 begins at block 402 wherein an artifact created in block 210 of FIG. 2 is received by the partner portal 108 and/or by the publisher service system 110. The receipt of the artifact corresponds to arrow 126.

At block 403, information indicating selection of a stack for validation is received. In some embodiments, this can include receiving at the publication service system 110 and/or at the partner portal 108 identification of a stack for validation from the customer tenancy 108 in the cloud computing environment 102. In some embodiments, the stack can have an associated stack identifier. In some embodiments, the information indicating selection of the stack for validation is received by the partner portal 108 and/or by the publisher service system 100 from the customer tenancy 104. Receipt of information indicating selection of the stack for validation corresponds to, and occurs subsequent to the selection of the stack for validation in block 212 of FIG. 2.

At block 404, information identifying the customer tenancy 104 of the stack selected for validation is retrieved by the partner portal 108 and/or by the publisher service system 100 from the customer tenancy 104. In some embodiments, this information can be retrieved by the partner portal 108 and/or by the publisher service system 100 from the customer tenancy 104 according to the policies of the customer tenancy 104 received in block 202 of FIG. 2. In some embodiments, the retrieval of information identifying the customer tenancy 104 of the stack selected for validation corresponds to, and occurs in connection with the providing of customer tenancy identification of block 214 of FIG. 2, and is represented by arrows 128 of FIG. 1.

At block 406, job information relevant to the stack selected for validation is retrieved from the customer tenancy 104. In some embodiments, the job information relevant to the stack selected for validation can be retrieved from the customer tenancy 104 by the partner portal 108 and/or by the publisher service system 110 accessing the partner tenancy 104 and/or querying the customer tenancy 104 for the job information relevant to the selected stack. In some embodiments, this can include, for example, the partner portal 108 and/or by the publisher service system 110 accessing the partner tenancy 104 and querying the partner tenancy 104 for a list of jobs associated with the stack. In some embodiments, at least some of the jobs associated with the stack include at least one of: APPLY; or DESTROY. In some embodiments, this information can indicate, for each job performed on the stack, whether the job was successfully completed.

In some embodiments, and as jobs can be performed multiple times, the job information relevant to the stack that is retrieved in block 406 can be the most recently gathered job information for each job performed on the stack. For example, if each of the jobs PLAN, APPLY, and DESTROY were performed multiple times, then the information retrieved in block 406 would be the most recent of each of the jobs PLAN, APPLY, and DESTROY, or in other words, the most recent PLAN outcome, the most recent APPLY outcome, and the most recent DESTROY outcome would be retrieved in block 406.

In some embodiments, this information relating to the completion of jobs can be retrieved by the partner portal 108 and/or by the publisher service system 100 from the customer tenancy 104 according to the policies of the customer tenancy 104 received in block 202 of FIG. 2. In some embodiments, the retrieval of job information corresponds to, and occurs in connection with the providing of job information of block 216 of FIG. 2, and is represented by arrows 130 of FIG. 1.

At block 408, the validation status of the stack is determined based on the retrieved job information. In some embodiments, the validation status of the stack can be determined based on which of the most recently performed jobs were successful. In some embodiments, for example, the stack can be validated if the most recent APPLY and DESTROY jobs performed on the stack were successful. In some embodiments, the stack cannot be validated if the most recent APPLY and DESTROY jobs performed on the stack were unsuccessful. Thus, in some embodiments, determining the validation status of the stack can include identifying the latest one or more jobs with operation APPLY or DESTROY, and determining the lifecycle-state of the latest one or more jobs with operation APPLY or DESTROY. In some embodiments, for example, the jobs can have a lifecycle-state of, for example, “ACTIVE”, “SUCCEEDED”, and/or “FAILED”. In some embodiments, it can be determined that the stack is valid when the lifecycle-state of each of the jobs APPLY and DESTROY is SUCCEEDED.

At block 410, the stack is downloaded from the customer tenancy 104 to the partner portal 108. At block 412, the downloaded stack is scanned for viruses and/or malware.

At decision step 414, and based on the validation status determined in block 408, and, in some embodiments, based on the virus scan of block 412, the partner portal 108 and/or the publisher service system 110 determines whether to validate the stack. In some embodiments, when it is determined in block 408 that the stack can be validated, then it is determined at decision step 414 to validate the stack. Thus, in some embodiments, the validation status of the stack can be determined based on the job information retrieved in block 406. In some embodiments, when it is determined in block 408 that the stack can be validated and when it is determined in block 412 that the stack does not contain viruses and/or malware, then it is determined at decision step 414 to validate the stack.

If it is determined at decision state 414 to not validate the stack, then the process 400 proceeds to block 416, and the stack is designated as an invalid stack. Alternatively, when it is determined at decision step 414 to validate the stack, then the process 400 proceeds to block 418 and the stack is designated as a valid stack. The designation of the stack as either valid or invalid is indicated with arrow 132 of FIG. 1, and can precede the receipt of the indication of validation status of block 218 of FIG. 2.

At step 420, a request to publish the stack is received. In some embodiments, this request can be received by the partner portal 108 and/or by the publisher service system 110 from the customer device 106 and/or from the customer tenancy 104. At block 422, the stack is published. In some embodiments, this can include the partner portal 108 and/or the publisher service system 110 providing the stack to the DCDF 112 as indicated by arrow 136 of FIG. 1. Alternatively, in some embodiments, the DCDF 112 can receive the stack directly from the customer tenancy 104 as indicated by arrow 138 of FIG. 1. In some embodiments, the DCDF 112 publishes the stack.

In some embodiments, all or portions of the process 400 can be embodied in the following exemplary algorithm. The following exemplary algorithm is performed for the stack assigned the stack ID:

```
“ocid1.ormstack.oc1.iad.aaaaaaaarm2oazo4sd2u7ujpx2q6hfbhulbhfe7nsyvh45jchqnqkp
k76i7a”
  # query the stack id provided by the partner and check from the output
  that the job has ″lifecycle-state″: ″ACTIVE″
  oci resource-manager stack get --stack-id
  ocid1.ormstack.oc1.iad.aaaaaaaarm2oazo4sd2u7ujpx2q6hfbhulbhfe7nsyvh45jc
  hqnqkpk76i7a
  {
  ″data″: {
  ″compartment-id″:
  ″ocid1.compartment.oc1..aaaaaaaa6mc3agkix3xec7z7fty3iyaw3hwwwoblf7l3p73
  k4tp5ezavkxsq″,
  ″config-source″: {
  ″config-source-type″: ″ZIP_UPLOAD″,
  ″working-directory″: null
  },
  ″defined-tags″: { },
  ″description″: ″Provision a Compute instance in Oracle Cloud
  Infrastructure″,
  ″display-name″: ″stack-compute″,
  ″freeform-tags″: {
  ″TemplateName″: ″stack-compute″,
  ″TemplateSource″: ″ORM Template″
  },
  ″id″:
  ″ocid1.ormstack.oc1.iad.aaaaaaaarm2oazo4sd2u7ujpx2q6hfbhulbhfe7nsyvh45j
  chqnqkpk7617a″,
  ″lifecycle-state″: ″ACTIVE″,
  ″stack-drift-status″: ″NOT_CHECKED″,
  ″terraform-version″: ″0.12.x″,
  ″time-created″: ″2021-05-24T19:22:55.066000+00:00″,
  ″time-drift-last-checked″: null,
  ″variables″: {
  ″assign_public_ip″: ″false″,
  ″attachment_type″: ″iscsi″,
  ″block_storage_size_in_gbs″: ″50″,
  ″boot_volume_size_in_gbs″: ″50″,
  ″compartment_ocid″:
  ″ocid1.compartment.oc1..aaaaaaaa6mc3agkix3xec7z7fty3iyaw3hwwwoblf7l3p73
  k4tp5ezavkxsq″,
  ″hostname_label″: ″myHost″,
  ″instance_display_name″: ″testCompute″,
  ″instance_timeout″: ″25m″,
  ″ipxe_script″: ″″,
  ″preserve_boot_volume″: ″false″,
  ″private_ip″: ″″,
  ″region″: ″us-amdkcihj-1″,
  ″resource_platform″: ″linux″,
  ″shape″: ″VM.Standard2.1″,
  ″skip_source_dest_check″: ″false″,
  ″ssh_public_key″: ″ssh-rsa AAAAAAA...\n″,
  ″subnet_ocid″:
  ″ocid1.subnet.oc1.iad.aaaaaaaaqblpx6zxzfggfnu3wwkg6dkpqmfmxbze3engzkr4r
  o7cgakzquza″,
  ″tenancy_ocid″:
  ″ocid1.tenancy.oc1..aaaaaaaawjqcvyrvl34cexkgthbav267fmv5rbiapdw7xbjdjdg
  xndifseaa″,
  ″use_chap″: ″true″,
  ″user_data″: ″″,
  ″vnic_name″: ″myVNIC″
  }
  },
  ″etag″:
  ″48ed3625cb99d58f23d9a551eca2acda451eea2a1fe7a9d84f493887eea52cfe--
  gzip″
  }
  # get the list of jobs associated with the stack and
  # check that the latest jobs with operations APPLY and DESTROY have
  lifecycle-state = ″SUCCEEDED″
  oci resource-manager job list --stack-id
  ocid1.ormstack.oc1.iad.aaaaaaaarm2oazo4sd2u7ujpx2q6hfbhulbhfe7nsyvh45jc
  hqnqkpk76i7a
  {
  ″data″: [
  {
  ″apply-job-plan-resolution″: {
  ″is-auto-approved″: true,
  ″is-use-latest-job-id″: null,
  ″plan-job-id″: null
  },
  ″compartment-id″:
  ″ocid1.compartment.oc1..aaaaaaaa6mc3agkix3xec7z7fty3iyaw3hwwwoblf7l3p73
  k4tp5ezavkxsq″,
  ″defined-tags″: { },
  ″display-name″: ″apply-job-20210524123434″,
  ″freeform-tags″: { },
  ″id″:
  ″ocid1.ormjob.oc1.iad.aaaaaaaavkpc7wijbvxbtuj2ggwcy2a7xatepydmgs2z2fzg3
  emc3mmpv5mq″,
  ″job-operation-details″: {
  ″execution-plan-job-id″: null,
  ″execution-plan-strategy″: ″AUTO_APPROVED″,
  ″operation″: ″APPLY″
  },
  ″lifecycle-state″: ″SUCCEEDED″,
  ″operation″: ″APPLY″,
  ″resolved-plan-job-id″: null,
  ″stack-id″:
  ″ocid1.ormstack.oc1.iad.aaaaaaaarm2oazo4sd2u7ujpx2q6hfbhulbhfe7nsyvh45j
  chqnqkpk7617a″,
  ″time-created″: ″2021-05-24T19:34:40.179000+00:00″,
  ″time-finished″: ″2021-05-24T19:36:12.255000+00:00″
  },
  {
  ″Apply-job-plan-resolution″: {
  ″is-auto-approved″: null,
  ″is-use-latest-job-id″: null,
  ″plan-job-id″:
  ″ocid1.ormjob.oc1.iad.aaaaaaaans3etvnpjx53cq2hskfwqz46ymrsi4f2phcdhvnr2
  t63lngpqi4q″
  },
  ″compartment-id″:
  ″ocid1.compartment.ocl..aaaaaaaa6mc3agkix3xec7z7fty3iyaw3hwwwoblf7l3p73
  k4tp5ezavkxsq″,
  ″defined-tags″: { },
  ″display-name″: ″apply-job-20210524122934″,
  ″freeform-tags″: { },
  ″id″:
  ″ocid1.ormjob.oc1.iad.aaaaaaaalacijrndhvhpjbfib7hyfbqak4yajdbycoemdxr4v
  dhyahrfmhca″,
  ″job-operation-details″: {
  ″execution-plan-job-id″:
  ″ocid1.ormjob.oc1.iad.aaaaaaaans3etvnpjx53cq2hskfwqz46ymrsi4f2phcdhvnr2
  t63lngpqi4q″,
  ″execution-plan-strategy″: ″FROM_PLAN_JOB_ID″,
  ″operation″: ″APPLY″
  },
  ″lifecycle-state″: ″FAILED″,
  ″operation″: ″APPLY″,
  ″resolved-plan-job-id″:
  ″ocid1.ormjob.oc1.iad.aaaaaaaans3etvnpjx53cq2hskfwqz46ymrsi4f2phcdhvnr2
  t63lngpqi4q″,
  ″stack-id″:
  ″ocid1.ormstack.oc1.iad.aaaaaaaarm2oazo4sd2u7ujpx2q6hfbhulbhfe7nsyvh45j
  chqnqkpk7617a″,
  ″time-created″: ″2021-05-24T19:29:59.043000+00:00″,
  ″time-finished″: ″2021-05-24T19:32:14.297000+00:00″
  },
  {
  ″apply-job-plan-resolution″: null,
  ″compartment-id″:
  ″ocid1.compartment.oc1..aaaaaaaa6mc3agkix3xec7z7fty3iyaw3hwwwoblf7l3p73
  k4tp5ezavkxsq″,
  ″defined-tags″: { },
  ″display-name″: ″plan-job-20210524122713″,
  ″freeform-tags″: { },
  ″id″:
  ″ocid1.ormjob.oc1.iad.aaaaaaaans3etvnpjx53cq2hskfwqz46ymrsi4f2phcdhvnr2
  t63lngpqi4q″,
  ″job-operation-details″: {
  ″operation″: ″PLAN″
  },
  ″lifecycle-state″: ″SUCCEEDED″,
  ″operation″: ″PLAN″,
  ″resolved-plan-job-id″: null,
  ″stack-id″:
  ″ocid1.ormstack.oc1.iad.aaaaaaaarm2oazo4sd2u7ujpx2q6hfbhulbhfe7nsyvh45j
  chqnqkpk76i7a″,
  ″time-created″: ″2021-05-24T19:27:22.358000+00:00″,
  ″time-finished″: ″2021-05-24T19:27:57.537000+00:00″
  }
  ]
```

### Exemplary Embodiment

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, load balancing and clustering, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

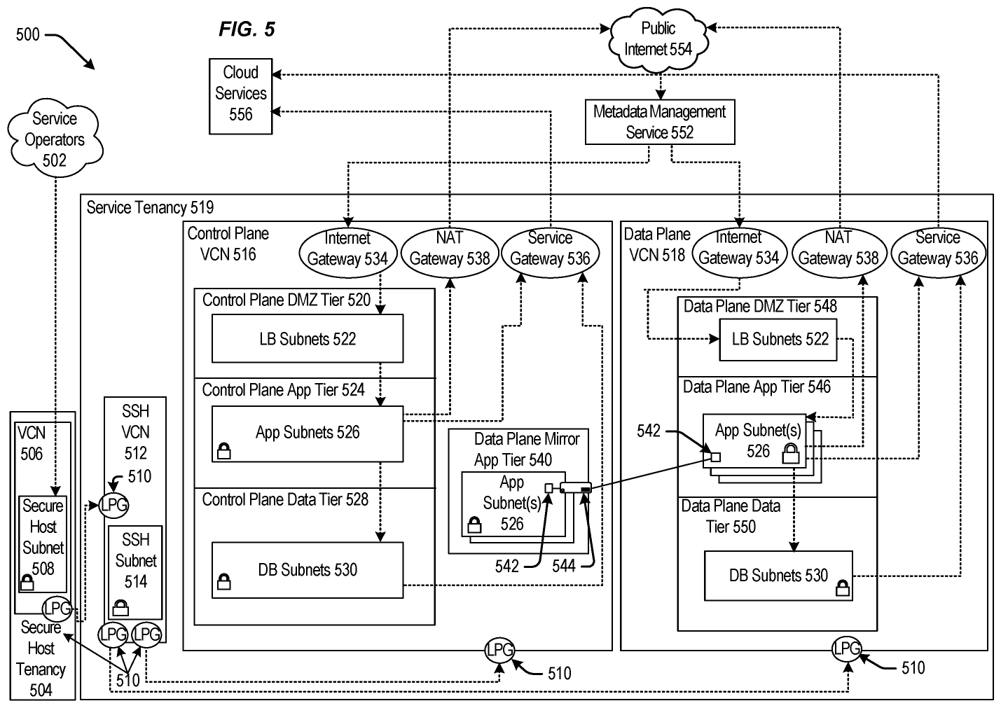

FIG. 5 is a block diagram 500 illustrating an example pattern of an IaaS architecture, according to at least one embodiment. Service operators 502 can be communicatively coupled to a secure host tenancy 504 that can include a virtual cloud network (VCN) 506 and a secure host subnet 508. In some examples, the service operators 502 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 506 and/or the Internet.

The VCN 506 can include a local peering gateway (LPG) 510 that can be communicatively coupled to a secure shell (SSH) VCN 512 via an LPG 510 contained in the SSH VCN 512. The SSH VCN 512 can include an SSH subnet 514, and the SSH VCN 512 can be communicatively coupled to a control plane VCN 516 via the LPG 510 contained in the control plane VCN 516. Also, the SSH VCN 512 can be communicatively coupled to a data plane VCN 518 via an LPG 510. The control plane VCN 516 and the data plane VCN 518 can be contained in a service tenancy 519 that can be owned and/or operated by the IaaS provider.

The control plane VCN 516 can include a control plane demilitarized zone (DMZ) tier 520 that acts as a perimeter network (e.g., portions of a corporate network between the corporate intranet and external networks). The DMZ-based servers may have restricted responsibilities and help keep breaches contained. Additionally, the DMZ tier 520 can include one or more load balancer (LB) subnet(s) 522, a control plane app tier 524 that can include app subnet(s) 526, a control plane data tier 528 that can include database (DB) subnet(s) 530(e.g., frontend DB subnet(s) and/or backend DB subnet(s)). The LB subnet(s) 522 contained in the control plane DMZ tier 520 can be communicatively coupled to the app subnet(s) 526 contained in the control plane app tier 524 and an Internet gateway 534 that can be contained in the control plane VCN 516, and the app subnet(s) 526 can be communicatively coupled to the DB subnet(s) 530 contained in the control plane data tier 528 and a service gateway 536 and a network address translation (NAT) gateway 538. The control plane VCN 516 can include the service gateway 536 and the NAT gateway 538.

The control plane VCN 516 can include a data plane mirror app tier 540 that can include app subnet(s) 526. The app subnet(s) 526 contained in the data plane mirror app tier 540 can include a virtual network interface controller (VNIC) 542 that can execute a compute instance 544. The compute instance 544 can communicatively couple the app subnet(s) 526 of the data plane mirror app tier 540 to app subnet(s) 526 that can be contained in a data plane app tier 546.

The data plane VCN 518 can include the data plane app tier 546, a data plane DMZ tier 548, and a data plane data tier 550. The data plane DMZ tier 548 can include LB subnet(s) 522 that can be communicatively coupled to the app subnet(s) 526 of the data plane app tier 546 and the Internet gateway 534 of the data plane VCN 518. The app subnet(s) 526 can be communicatively coupled to the service gateway 536 of the data plane VCN 518 and the NAT gateway 538 of the data plane VCN 518. The data plane data tier 550 can also include the DB subnet(s) 530 that can be communicatively coupled to the app subnet(s) 526 of the data plane app tier 546.

The Internet gateway 534 of the control plane VCN 516 and of the data plane VCN 518 can be communicatively coupled to a metadata management service 552 that can be communicatively coupled to public Internet 554. Public Internet 554 can be communicatively coupled to the NAT gateway 538 of the control plane VCN 516 and of the data plane VCN 518. The service gateway 536 of the control plane VCN 516 and of the data plane VCN 518 can be communicatively couple to cloud services 556.

In some examples, the service gateway 536 of the control plane VCN 516 or of the data plane VCN 518 can make application programming interface (API) calls to cloud services 556 without going through public Internet 554. The API calls to cloud services 556 from the service gateway 536 can be one-way: the service gateway 536 can make API calls to cloud services 556, and cloud services 556 can send requested data to the service gateway 536. But, cloud services 556 may not initiate API calls to the service gateway 536.

In some examples, the secure host tenancy 504 can be directly connected to the service tenancy 519, which may be otherwise isolated. The secure host subnet 508 can communicate with the SSH subnet 514 through an LPG 510 that may enable two-way communication over an otherwise isolated system. Connecting the secure host subnet 508 to the SSH subnet 514 may give the secure host subnet 508 access to other entities within the service tenancy 519.

The control plane VCN 516 may allow users of the service tenancy 519 to set up or otherwise provision desired resources. Desired resources provisioned in the control plane VCN 516 may be deployed or otherwise used in the data plane VCN 518. In some examples, the control plane VCN 516 can be isolated from the data plane VCN 518, and the data plane mirror app tier 540 of the control plane VCN 516 can communicate with the data plane app tier 546 of the data plane VCN 518 via VNICs 542 that can be contained in the data plane mirror app tier 540 and the data plane app tier 546.

In some examples, users of the system, or customers, can make requests, for example create, read, update, or delete (CRUD) operations, through public Internet 554 that can communicate the requests to the metadata management service 552. The metadata management service 552 can communicate the request to the control plane VCN 516 through the Internet gateway 534. The request can be received by the LB subnet(s) 522 contained in the control plane DMZ tier 520. The LB subnet(s) 522 may determine that the request is valid, and in response to this determination, the LB subnet(s) 522 can transmit the request to app subnet(s) 526 contained in the control plane app tier 524. If the request is validated and requires a call to public Internet 554, the call to public Internet 554 may be transmitted to the NAT gateway 538 that can make the call to public Internet 554. Memory that may be desired to be stored by the request can be stored in the DB subnet(s) 530.

In some examples, the data plane mirror app tier 540 can facilitate direct communication between the control plane VCN 516 and the data plane VCN 518. For example, changes, updates, or other suitable modifications to configuration may be desired to be applied to the resources contained in the data plane VCN 518. Via a VNIC 542, the control plane VCN 516 can directly communicate with, and can thereby execute the changes, updates, or other suitable modifications to configuration to, resources contained in the data plane VCN 518.

In some embodiments, the control plane VCN 516 and the data plane VCN 518 can be contained in the service tenancy 519. In this case, the user, or the customer, of the system may not own or operate either the control plane VCN 516 or the data plane VCN 518. Instead, the IaaS provider may own or operate the control plane VCN 516 and the data plane VCN 518, both of which may be contained in the service tenancy 519. This embodiment can enable isolation of networks that may prevent users or customers from interacting with other users', or other customers', resources. Also, this embodiment may allow users or customers of the system to store databases privately without needing to rely on public Internet 554, which may not have a desired level of threat prevention, for storage.

In other embodiments, the LB subnet(s) 522 contained in the control plane VCN 516 can be configured to receive a signal from the service gateway 536. In this embodiment, the control plane VCN 516 and the data plane VCN 518 may be configured to be called by a customer of the IaaS provider without calling public Internet 554. Customers of the IaaS provider may desire this embodiment since database(s) that the customers use may be controlled by the IaaS provider and may be stored on the service tenancy 519, which may be isolated from public Internet 554.

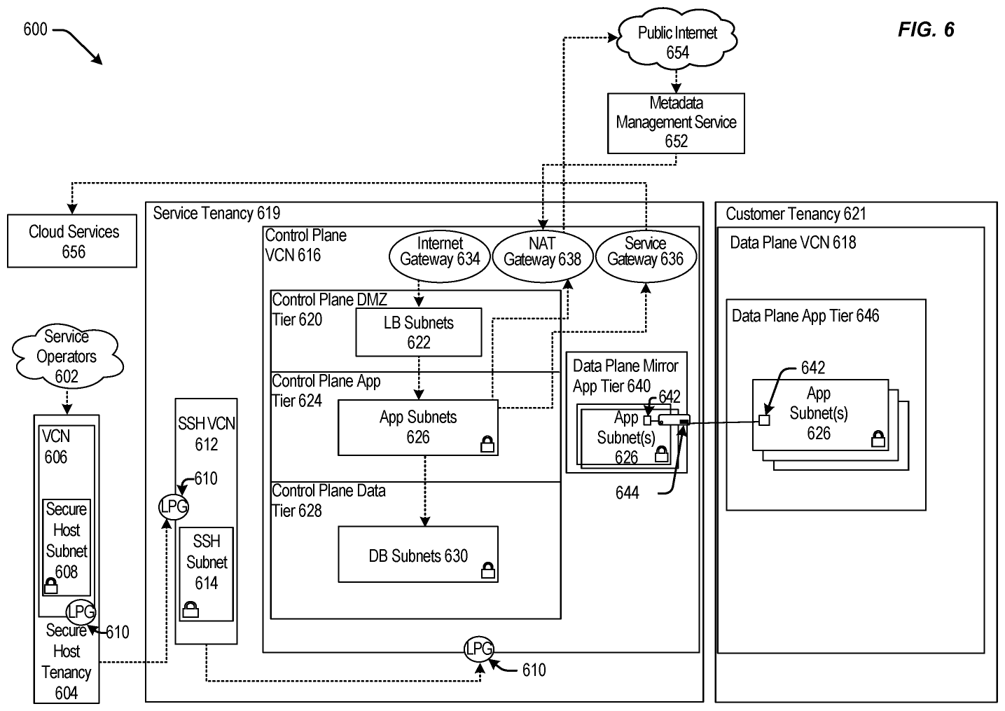

FIG. 6 is a block diagram 600 illustrating another example pattern of an IaaS architecture, according to at least one embodiment. Service operators 602 (e.g., service operators 502 of FIG. 5) can be communicatively coupled to a secure host tenancy 604 (e.g. the secure host tenancy 504 of FIG. 5) that can include a virtual cloud network (VCN) 606 (e.g. the VCN 506 of FIG. 5) and a secure host subnet 608 (e.g. the secure host subnet 508 of FIG. 5). The VCN 606 can include a local peering gateway (LPG) 610 (e.g., the LPG 510 of FIG. 5) that can be communicatively coupled to a secure shell (SSH) VCN 612 (e.g., the SSH VCN 512 of FIG. 5) via an LPG 510 contained in the SSH VCN 612. The SSH VCN 612 can include an SSH subnet 614 (e.g., the SSH subnet 514 of FIG. 5), and the SSH VCN 612 can be communicatively coupled to a control plane VCN 616 (e.g., the control plane VCN 516 of FIG. 5) via an LPG 610 contained in the control plane VCN 616. The control plane VCN 616 can be contained in a service tenancy 619 (e.g., the service tenancy 519 of FIG. 5), and the data plane VCN 618 (e.g. the data plane VCN 518 of FIG. 5) can be contained in a customer tenancy 621 that may be owned or operated by users, or customers, of the system.

The control plane VCN 616 can include a control plane DMZ tier 620 (e.g. the control plane DMZ tier 520 of FIG. 5) that can include LB subnet(s) 622 (e.g. LB subnet(s) 522 of FIG. 5), a control plane app tier 624 (e.g. the control plane app tier 524 of FIG. 5) that can include app subnet(s) 626 (e.g. app subnet(s) 526 of FIG. 5), a control plane data tier 628 (e.g. the control plane data tier 528 of FIG. 5) that can include database (DB) subnet(s) 630 (e.g. similar to DB subnet(s) 530 of FIG. 5). The LB subnet(s) 622 contained in the control plane DMZ tier 620 can be communicatively coupled to the app subnet(s) 626 contained in the control plane app tier 624 and an Internet gateway 634 (e.g. the Internet gateway 534 of FIG. 5) that can be contained in the control plane VCN 616, and the app subnet(s) 626 can be communicatively coupled to the DB subnet(s) 630 contained in the control plane data tier 628 and a service gateway 636 (e.g. the service gateway of FIG. 5) and a network address translation (NAT) gateway 638 (e.g. the NAT gateway 538 of FIG. 5). The control plane VCN 616 can include the service gateway 636 and the NAT gateway 638.

The control plane VCN 616 can include a data plane mirror app tier 640 (e.g., the data plane mirror app tier 540 of FIG. 5) that can include app subnet(s) 626. The app subnet(s) 626 contained in the data plane mirror app tier 640 can include a virtual network interface controller (VNIC) 642 (e.g., the VNIC of 542) that can execute a compute instance 644 (e.g., similar to the compute instance 544 of FIG. 5). The compute instance 644 can facilitate communication between the app subnet(s) 626 of the data plane mirror app tier 640 and the app subnet(s) 626 that can be contained in a data plane app tier 646 (e.g. the data plane app tier 546 of FIG. 5) via the VNIC 642 contained in the data plane mirror app tier 640 and the VNIC 642 contained in the data plane app tier 646.

The Internet gateway 634 contained in the control plane VCN 616 can be communicatively coupled to a metadata management service 652 (e.g., the metadata management service 552 of FIG. 5) that can be communicatively coupled to public Internet 654 (e.g., public Internet 554 of FIG. 5). Public Internet 654 can be communicatively coupled to the NAT gateway 638 contained in the control plane VCN 616. The service gateway 636 contained in the control plane VCN 616 can be communicatively couple to cloud services 656 (e.g., cloud services 556 of FIG. 5).

In some examples, the data plane VCN 618 can be contained in the customer tenancy 621. In this case, the IaaS provider may provide the control plane VCN 616 for each customer, and the IaaS provider may, for each customer, set up a unique compute instance 644 that is contained in the service tenancy 619. Each compute instance 644 may allow communication between the control plane VCN 616, contained in the service tenancy 619, and the data plane VCN 618 that is contained in the customer tenancy 621. The compute instance 644 may allow resources, that are provisioned in the control plane VCN 616 that is contained in the service tenancy 619, to be deployed or otherwise used in the data plane VCN 618 that is contained in the customer tenancy 621.

In other examples, the customer of the IaaS provider may have databases that live in the customer tenancy 621. In this example, the control plane VCN 616 can include the data plane mirror app tier 640 that can include app subnet(s) 626. The data plane mirror app tier 640 can reside in the data plane VCN 618, but the data plane mirror app tier 640 may not live in the data plane VCN 618. That is, the data plane mirror app tier 640 may have access to the customer tenancy 621, but the data plane mirror app tier 640 may not exist in the data plane VCN 618 or be owned or operated by the customer of the IaaS provider. The data plane mirror app tier 640 may be configured to make calls to the data plane VCN 618 but may not be configured to make calls to any entity contained in the control plane VCN 616. The customer may desire to deploy or otherwise use resources in the data plane VCN 618 that are provisioned in the control plane VCN 616, and the data plane mirror app tier 640 can facilitate the desired deployment, or other usage of resources, of the customer.

In some embodiments, the customer of the IaaS provider can apply filters to the data plane VCN 618. In this embodiment, the customer can determine what the data plane VCN 618 can access, and the customer may restrict access to public Internet 654 from the data plane VCN 618. The IaaS provider may not be able to apply filters or otherwise control access of the data plane VCN 618 to any outside networks or databases. Applying filters and controls by the customer onto the data plane VCN 618, contained in the customer tenancy 621, can help isolate the data plane VCN 618 from other customers and from public Internet 654.

In some embodiments, cloud services 656 can be called by the service gateway 636 to access services that may not exist on public Internet 654, on the control plane VCN 616, or on the data plane VCN 618. The connection between cloud services 656 and the control plane VCN 616 or the data plane VCN 618 may not be live or continuous. Cloud services 656 may exist on a different network owned or operated by the IaaS provider. Cloud services 656 may be configured to receive calls from the service gateway 636 and may be configured to not receive calls from public Internet 654. Some cloud services 656 may be isolated from other cloud services 656, and the control plane VCN 616 may be isolated from cloud services 656 that may not be in the same region as the control plane VCN 616. For example, the control plane VCN 616 may be located in “Region 1,” and cloud service “Deployment 1,” may be located in Region 1 and in “Region 2.” If a call to Deployment 1 is made by the service gateway 636 contained in the control plane VCN 616 located in Region 1, the call may be transmitted to Deployment 1 in Region 1. In this example, the control plane VCN 616, or Deployment 1 in Region 1, may not be communicatively coupled to, or otherwise in communication with, Deployment 1 in Region 2.

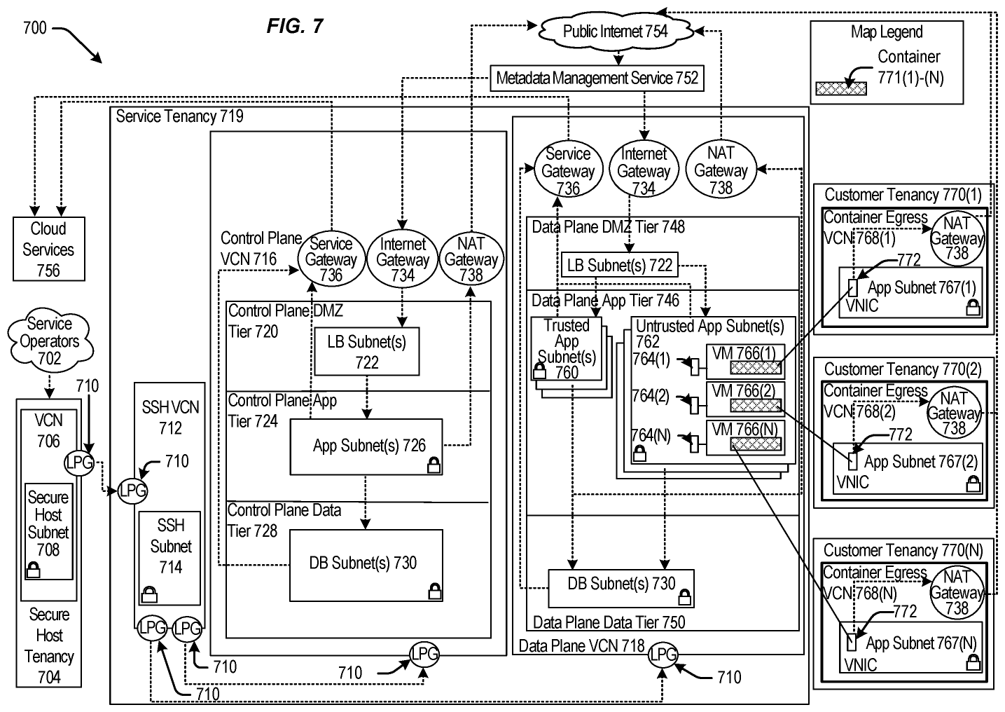

FIG. 7 is a block diagram 700 illustrating another example pattern of an IaaS architecture, according to at least one embodiment. Service operators 702 (e.g., service operators 502 of FIG. 5) can be communicatively coupled to a secure host tenancy 704 (e.g. the secure host tenancy 504 of FIG. 5) that can include a virtual cloud network (VCN) 706 (e.g. the VCN 506 of FIG. 5) and a secure host subnet 708 (e.g. the secure host subnet 508 of FIG. 5). The VCN 706 can include an LPG 710 (e.g., the LPG 510 of FIG. 5) that can be communicatively coupled to an SSH VCN 712 (e.g., the SSH VCN 512 of FIG. 5) via an LPG 710 contained in the SSH VCN 712. The SSH VCN 712 can include an SSH subnet 714 (e.g. the SSH subnet 514 of FIG. 5), and the SSH VCN 712 can be communicatively coupled to a control plane VCN 716 (e.g. the control plane VCN 516 of FIG. 5) via an LPG 710 contained in the control plane VCN 716 and to a data plane VCN 718 (e.g. the data plane 518 of FIG. 5) via an LPG 710 contained in the data plane VCN 718. The control plane VCN 716 and the data plane VCN 718 can be contained in a service tenancy 719 (e.g., the service tenancy 519 of FIG. 5).

The control plane VCN 716 can include a control plane DMZ tier 720 (e.g. the control plane DMZ tier 520 of FIG. 5) that can include load balancer (LB) subnet(s) 722 (e.g. LB subnet(s) 522 of FIG. 5), a control plane app tier 724 (e.g. the control plane app tier 524 of FIG. 5) that can include app subnet(s) 726 (e.g. similar to app subnet(s) 526 of FIG. 5), a control plane data tier 728 (e.g. the control plane data tier 528 of FIG. 5) that can include DB subnet(s) 730. The LB subnet(s) 722 contained in the control plane DMZ tier 720 can be communicatively coupled to the app subnet(s) 726 contained in the control plane app tier 724 and to an Internet gateway 734 (e.g. the Internet gateway 534 of FIG. 5) that can be contained in the control plane VCN 716, and the app subnet(s) 726 can be communicatively coupled to the DB subnet(s) 730 contained in the control plane data tier 728 and to a service gateway 736 (e.g. the service gateway of FIG. 5) and a network address translation (NAT) gateway 738 (e.g. the NAT gateway 538 of FIG. 5). The control plane VCN 716 can include the service gateway 736 and the NAT gateway 738.

The data plane VCN 718 can include a data plane app tier 746 (e.g., the data plane app tier 546 of FIG. 5), a data plane DMZ tier 748 (e.g., the data plane DMZ tier 548 of FIG. 5), and a data plane data tier 750 (e.g. the data plane data tier 550 of FIG. 5). The data plane DMZ tier 748 can include LB subnet(s) 722 that can be communicatively coupled to trusted app subnet(s) 760 and untrusted app subnet(s) 762 of the data plane app tier 746 and the Internet gateway 734 contained in the data plane VCN 718. The trusted app subnet(s) 760 can be communicatively coupled to the service gateway 736 contained in the data plane VCN 718, the NAT gateway 738 contained in the data plane VCN 718, and DB subnet(s) 730 contained in the data plane data tier 750. The untrusted app subnet(s) 762 can be communicatively coupled to the service gateway 736 contained in the data plane VCN 718 and DB subnet(s) 730 contained in the data plane data tier 750. The data plane data tier 750 can include DB subnet(s) 730 that can be communicatively coupled to the service gateway 736 contained in the data plane VCN 718.

The untrusted app subnet(s) 762 can include one or more primary VNICs 764(1)-(N) that can be communicatively coupled to tenant virtual machines (VMs) 766(1)-(N). Each tenant VM 766(1)-(N) can be communicatively coupled to a respective app subnet 767(1)-(N) that can be contained in respective container egress VCNs 768(1)-(N) that can be contained in respective customer tenancies 770(1)-(N). Respective secondary VNICs 772(1)-(N) can facilitate communication between the untrusted app subnet(s) 762 contained in the data plane VCN 718 and the app subnet contained in the container egress VCNs 768(1)-(N). Each container egress VCNs 768(1)-(N) can include a NAT gateway 738 that can be communicatively coupled to public Internet 754 (e.g., public Internet 554 of FIG. 5).

The Internet gateway 734 contained in the control plane VCN 716 and contained in the data plane VCN 718 can be communicatively coupled to a metadata management service 752 (e.g., the metadata management system 552 of FIG. 5) that can be communicatively coupled to public Internet 754. Public Internet 754 can be communicatively coupled to the NAT gateway 738 contained in the control plane VCN 716 and contained in the data plane VCN 718. The service gateway 736 contained in the control plane VCN 716 and contained in the data plane VCN 718 can be communicatively couple to cloud services 756.

In some embodiments, the data plane VCN 718 can be integrated with customer tenancies 770. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane tier app 746. Code to run the function may be executed in the VMs 766(1)-(N), and the code may not be configured to run anywhere else on the data plane VCN 718. Each VM 766(1)-(N) may be connected to one customer tenancy 770. Respective containers 771(1)-(N) contained in the VMs 766(1)-(N) may be configured to run the code. In this case, there can be a dual isolation (e.g., the containers 771(1)-(N) running code, where the containers 771(1)-(N) may be contained in at least the VM 766(1)-(N) that are contained in the untrusted app subnet(s) 762), which may help prevent incorrect or otherwise undesirable code from damaging the network of the IaaS provider or from damaging a network of a different customer. The containers 771(1)-(N) may be communicatively coupled to the customer tenancy 770 and may be configured to transmit or receive data from the customer tenancy 770. The containers 771(1)-(N) may not be configured to transmit or receive data from any other entity in the data plane VCN 718. Upon completion of running the code, the IaaS provider may kill or otherwise dispose of the containers 771(1)-(N).

In some embodiments, the trusted app subnet(s) 760 may run code that may be owned or operated by the IaaS provider. In this embodiment, the trusted app subnet(s) 760 may be communicatively coupled to the DB subnet(s) 730 and be configured to execute CRUD operations in the DB subnet(s) 730. The untrusted app subnet(s) 762 may be communicatively coupled to the DB subnet(s) 730, but in this embodiment, the untrusted app subnet(s) may be configured to execute read operations in the DB subnet(s) 730. The containers 771(1)-(N) that can be contained in the VM 766(1)-(N) of each customer and that may run code from the customer may not be communicatively coupled with the DB subnet(s) 730.

In other embodiments, the control plane VCN 716 and the data plane VCN 718 may not be directly communicatively coupled. In this embodiment, there may be no direct communication between the control plane VCN 716 and the data plane VCN 718. However, communication can occur indirectly through at least one method. An LPG 710 may be established by the IaaS provider that can facilitate communication between the control plane VCN 716 and the data plane VCN 718. In another example, the control plane VCN 716 or the data plane VCN 718 can make a call to cloud services 756 via the service gateway 736. For example, a call to cloud services 756 from the control plane VCN 716 can include a request for a service that can communicate with the data plane VCN 718.

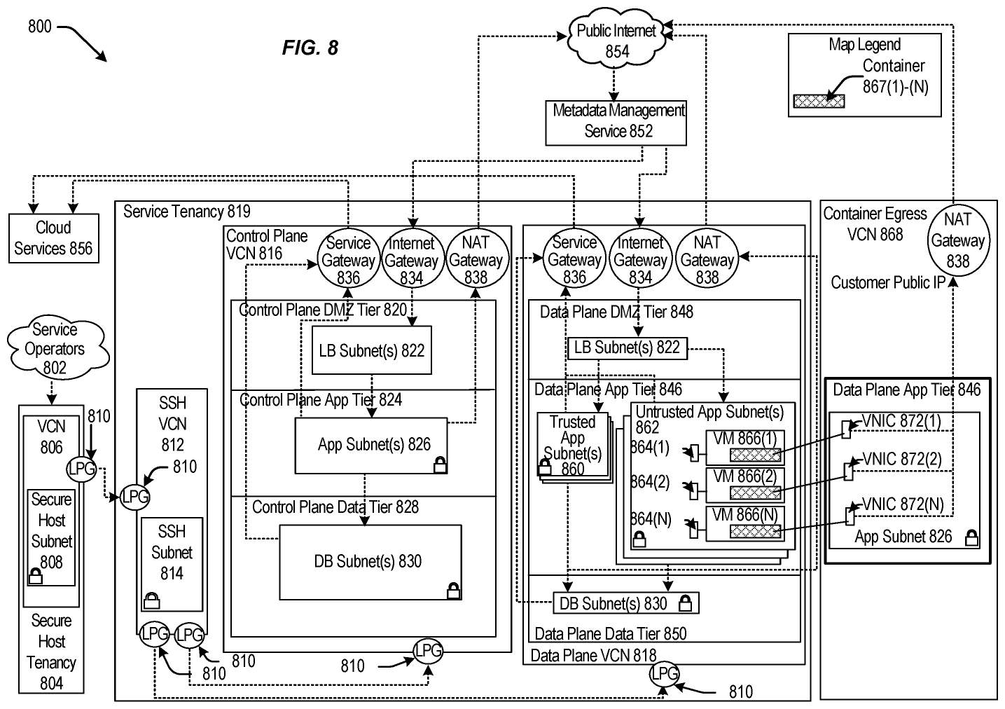

FIG. 8 is a block diagram 800 illustrating another example pattern of an IaaS architecture, according to at least one embodiment. Service operators 802 (e.g., service operators 502 of FIG. 5) can be communicatively coupled to a secure host tenancy 804 (e.g. the secure host tenancy 504 of FIG. 5) that can include a virtual cloud network (VCN) 806 (e.g. the VCN 506 of FIG. 5) and a secure host subnet 808 (e.g. the secure host subnet 508 of FIG. 5). The VCN 806 can include an LPG 810 (e.g., the LPG 510 of FIG. 5) that can be communicatively coupled to an SSH VCN 812 (e.g., the SSH VCN 512 of FIG. 5) via an LPG 810 contained in the SSH VCN 812. The SSH VCN 812 can include an SSH subnet 814 (e.g. the SSH subnet 514 of FIG. 5), and the SSH VCN 812 can be communicatively coupled to a control plane VCN 816 (e.g. the control plane VCN 516 of FIG. 5) via an LPG 810 contained in the control plane VCN 816 and to a data plane VCN 818 (e.g. the data plane 518 of FIG. 5) via an LPG 810 contained in the data plane VCN 818. The control plane VCN 816 and the data plane VCN 818 can be contained in a service tenancy 819 (e.g., the service tenancy 519 of FIG. 5).

The control plane VCN 816 can include a control plane DMZ tier 820 (e.g. the control plane DMZ tier 520 of FIG. 5) that can include LB subnet(s) 822 (e.g. LB subnet(s) 522 of FIG. 5), a control plane app tier 824 (e.g. the control plane app tier 524 of FIG. 5) that can include app subnet(s) 826 (e.g. app subnet(s) 526 of FIG. 5), a control plane data tier 828 (e.g. the control plane data tier 528 of FIG. 5) that can include DB subnet(s) 830 (e.g. DB subnet(s) 730 of FIG. 7). The LB subnet(s) 822 contained in the control plane DMZ tier 820 can be communicatively coupled to the app subnet(s) 826 contained in the control plane app tier 824 and to an Internet gateway 834 (e.g. the Internet gateway 534 of FIG. 5) that can be contained in the control plane VCN 816, and the app subnet(s) 826 can be communicatively coupled to the DB subnet(s) 830 contained in the control plane data tier 828 and to a service gateway 836 (e.g. the service gateway of FIG. 5) and a network address translation (NAT) gateway 838 (e.g. the NAT gateway 538 of FIG. 5). The control plane VCN 816 can include the service gateway 836 and the NAT gateway 838.

The data plane VCN 818 can include a data plane app tier 846 (e.g., the data plane app tier 546 of FIG. 5), a data plane DMZ tier 848 (e.g., the data plane DMZ tier 548 of FIG. 5), and a data plane data tier 850 (e.g. the data plane data tier 550 of FIG. 5). The data plane DMZ tier 848 can include LB subnet(s) 822 that can be communicatively coupled to trusted app subnet(s) 860 (e.g. trusted app subnet(s) 760 of FIG. 7) and untrusted app subnet(s) 862 (e.g. untrusted app subnet(s) 762 of FIG. 7) of the data plane app tier 846 and the Internet gateway 834 contained in the data plane VCN 818. The trusted app subnet(s) 860 can be communicatively coupled to the service gateway 836 contained in the data plane VCN 818, the NAT gateway 838 contained in the data plane VCN 818, and DB subnet(s) 830 contained in the data plane data tier 850. The untrusted app subnet(s) 862 can be communicatively coupled to the service gateway 836 contained in the data plane VCN 818 and DB subnet(s) 830 contained in the data plane data tier 850. The data plane data tier 850 can include DB subnet(s) 830 that can be communicatively coupled to the service gateway 836 contained in the data plane VCN 818.

The untrusted app subnet(s) 862 can include primary VNICs 864(1)-(N) that can be communicatively coupled to tenant virtual machines (VMs) 866(1)-(N) residing within the untrusted app subnet(s) 862. Each tenant VM 866(1)-(N) can run code in a respective container 867(1)-(N), and be communicatively coupled to an app subnet 826 that can be contained in a data plane app tier 846 that can be contained in a container egress VCN 868. Respective secondary VNICs 872(1)-(N) can facilitate communication between the untrusted app subnet(s) 862 contained in the data plane VCN 818 and the app subnet contained in the container egress VCN 868. The container egress VCN can include a NAT gateway 838 that can be communicatively coupled to public Internet 854 (e.g., public Internet 554 of FIG. 5).

The Internet gateway 834 contained in the control plane VCN 816 and contained in the data plane VCN 818 can be communicatively coupled to a metadata management service 852 (e.g., the metadata management system 552 of FIG. 5) that can be communicatively coupled to public Internet 854. Public Internet 854 can be communicatively coupled to the NAT gateway 838 contained in the control plane VCN 816 and contained in the data plane VCN 818. The service gateway 836 contained in the control plane VCN 816 and contained in the data plane VCN 818 can be communicatively couple to cloud services 856.

In some examples, the pattern illustrated by the architecture of block diagram 800 of FIG. 8 may be considered an exception to the pattern illustrated by the architecture of block diagram 700 of FIG. 7 and may be desirable for a customer of the IaaS provider if the IaaS provider cannot directly communicate with the customer (e.g., a disconnected region). The respective containers 867(1)-(N) that are contained in the VMs 866(1)-(N) for each customer can be accessed in real-time by the customer. The containers 867(1)-(N) may be configured to make calls to respective secondary VNICs 872(1)-(N) contained in app subnet(s) 826 of the data plane app tier 846 that can be contained in the container egress VCN 868. The secondary VNICs 872(1)-(N) can transmit the calls to the NAT gateway 838 that may transmit the calls to public Internet 854. In this example, the containers 867(1)-(N) that can be accessed in real-time by the customer can be isolated from the control plane VCN 816 and can be isolated from other entities contained in the data plane VCN 818. The containers 867(1)-(N) may also be isolated from resources from other customers.

In other examples, the customer can use the containers 867(1)-(N) to call cloud services 856. In this example, the customer may run code in the containers 867(1)-(N) that requests a service from cloud services 856. The containers 867(1)-(N) can transmit this request to the secondary VNICs 872(1)-(N) that can transmit the request to the NAT gateway that can transmit the request to public Internet 854. Public Internet 854 can transmit the request to LB subnet(s) 822 contained in the control plane VCN 816 via the Internet gateway 834. In response to determining the request is valid, the LB subnet(s) can transmit the request to app subnet(s) 826 that can transmit the request to cloud services 856 via the service gateway 836.

It should be appreciated that IaaS architectures 500, 600, 700, 800 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

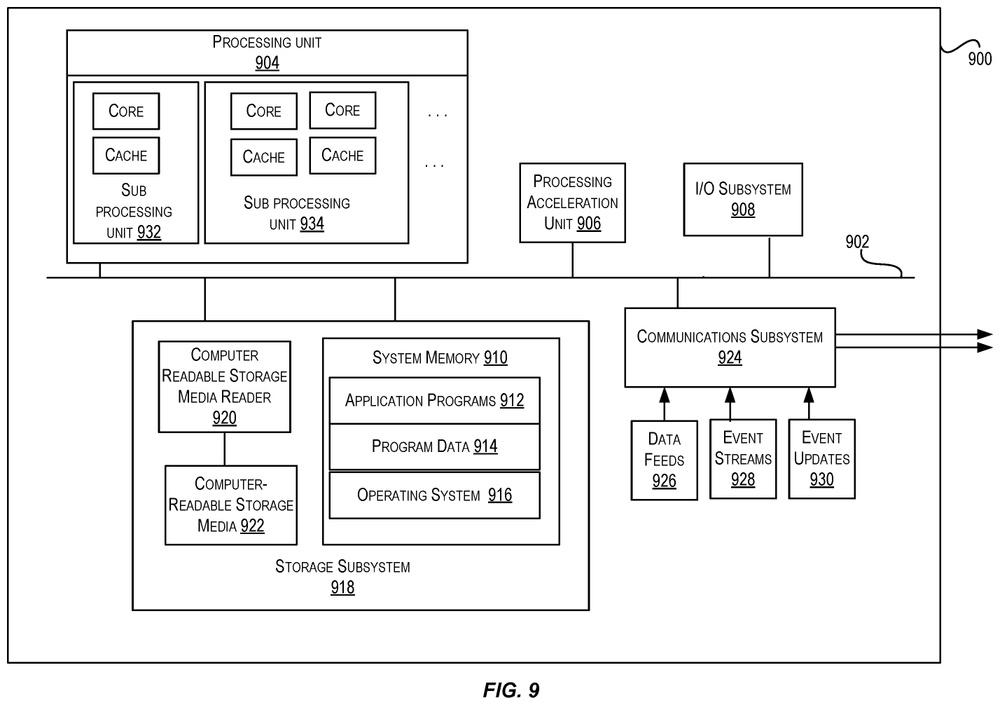

FIG. 9 illustrates an example computer system 900, in which various embodiments may be implemented. The system 900 may be used to implement any of the computer systems described above. As shown in the figure, computer system 900 includes a processing unit 904 that communicates with a number of peripheral subsystems via a bus subsystem 902. These peripheral subsystems may include a processing acceleration unit 906, an I/O subsystem 908, a storage subsystem 918 and a communications subsystem 924. Storage subsystem 918 includes tangible computer-readable storage media 922 and a system memory 910.

Bus subsystem 902 provides a mechanism for letting the various components and subsystems of computer system 900 communicate with each other as intended. Although bus subsystem 902 is shown schematically as a single bus, alternative embodiments of the bus subsystem may utilize multiple buses. Bus subsystem 902 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 904, which can be implemented as one or more integrated circuits (e.g., a conventional microprocessor or microcontroller), controls the operation of computer system 900. One or more processors may be included in processing unit 904. These processors may include single core or multicore processors. In certain embodiments, processing unit 904 may be implemented as one or more independent processing units 932 and/or 934 with single or multicore processors included in each processing unit. In other embodiments, processing unit 904 may also be implemented as a quad-core processing unit formed by integrating two dual-core processors into a single chip.

In various embodiments, processing unit 904 can execute a variety of programs in response to program code and can maintain multiple concurrently executing programs or processes. At any given time, some or all of the program code to be executed can be resident in processor(s) 904 and/or in storage subsystem 918. Through suitable programming, processor(s) 904 can provide various functionalities described above. Computer system 900 may additionally include a processing acceleration unit 906, which can include a digital signal processor (DSP), a special-purpose processor, and/or the like.

I/O subsystem 908 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 900 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 900 may comprise a storage subsystem 918 that comprises software elements, shown as being currently located within a system memory 910. System memory 910 may store program instructions that are loadable and executable on processing unit 904, as well as data generated during the execution of these programs.

Depending on the configuration and type of computer system 900, system memory 910 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 904. In some implementations, system memory 910 may include multiple different types of memory, such as static random access memory (SRAM) or dynamic random access memory (DRAM). In some implementations, a basic input/output system (BIOS), containing the basic routines that help to transfer information between elements within computer system 900, such as during start-up, may typically be stored in the ROM. By way of example, and not limitation, system memory 910 also illustrates application programs 912, which may include client applications, Web browsers, mid-tier applications, relational database management systems (RDBMS), etc., program data 914, and an operating system 916. By way of example, operating system 916 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 5 OS, and Palm® OS operating systems.

Storage subsystem 918 may also provide a tangible computer-readable storage medium for storing the basic programming and data constructs that provide the functionality of some embodiments. Software (programs, code modules, instructions) that when executed by a processor provide the functionality described above may be stored in storage subsystem 918. These software modules or instructions may be executed by processing unit 904. Storage subsystem 918 may also provide a repository for storing data used in accordance with the present disclosure.

Storage subsystem 900 may also include a computer-readable storage media reader 920 that can further be connected to computer-readable storage media 922. Together and, optionally, in combination with system memory 910, computer-readable storage media 922 may comprehensively represent remote, local, fixed, and/or removable storage devices plus storage media for temporarily and/or more permanently containing, storing, transmitting, and retrieving computer-readable information.

Computer-readable storage media 922 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 900.

By way of example, computer-readable storage media 922 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 922 may include, but is not limited to, Zip® drives, flash memory cards, universal serial bus (USB) flash drives, secure digital (SD) cards, DVD disks, digital video tape, and the like. Computer-readable storage media 922 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 900.

Communications subsystem 924 provides an interface to other computer systems and networks. Communications subsystem 924 serves as an interface for receiving data from and transmitting data to other systems from computer system 900. For example, communications subsystem 924 may enable computer system 900 to connect to one or more devices via the Internet. In some embodiments communications subsystem 924 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 924 can provide wired network connectivity (e.g., Ethernet) in addition to or instead of a wireless interface.

In some embodiments, communications subsystem 924 may also receive input communication in the form of structured and/or unstructured data feeds 926, event streams 928, event updates 930, and the like on behalf of one or more users who may use computer system 900.

By way of example, communications subsystem 924 may be configured to receive data feeds 926 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 924 may also be configured to receive data in the form of continuous data streams, which may include event streams 928 of real-time events and/or event updates 930, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 924 may also be configured to output the structured and/or unstructured data feeds 926, event streams 928, event updates 930, and the like to one or more databases that may be in communication with one or more streaming data source computers coupled to computer system 900.

Computer system 900 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 900 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A method comprising:
receiving at a publication service system identification of a stack for validation from a customer tenancy in a cloud computing environment, the stack having an associated stack identifier;
retrieving with the publication service system job information from the customer tenancy relevant to the stack;
determining validation status of the stack based on the retrieved job information; and
designating the stack as a valid stack when it is determined that the stack is valid.

2. The method of claim 1, further comprising receiving in the cloud computing environment policies allowing access of the customer tenancy by the publication service system.

3. The method of claim 2, wherein the policies allowing access of the customer tenancy by the publication service system allows the publication service system to read at least one of: tenant in the customer tenancy; compartments in the customer tenancy; stacks in the customer tenancy; or jobs in the customer tenancy.

4. The method of claim 2, further comprising receiving a stack in the customer tenancy.

5. The method of claim 4, wherein the stack is received in the customer tenancy by uploading the stack to the customer tenancy.

6. The method of claim 4, further comprising: testing the stack in the customer tenancy by performing a plurality of jobs; and storing job information in the customer tenancy and associated with the stack.

7. The method of claim 6, wherein the plurality of jobs comprise at least one of: PLAN; APPLY; or DESTROY.

8. The method of claim 1, wherein receiving identification of the stack comprises receiving an artifact.

9. The method of claim 1, wherein retrieving job information from the customer tenancy relevant to the stack comprises accessing with the publication service system the customer tenancy.

10. The method of claim 9, wherein retrieving job information from the customer tenancy relevant to the stack comprises querying the customer tenancy for a list of jobs associated with the stack.

11. The method of claim 10, wherein at least some of the jobs associated with the task correspond to validation tests and include at least one of: APPLY; or DESTROY.

12. The method of claim 11, wherein determining validation status of the stack based on the retrieved job information comprises: identifying the latest one or more jobs with operation APPLY or DESTROY; and determining the lifecycle-state of the latest one or 3 more jobs with operation APPLY or DESTROY.

13. The method of claim 1, wherein it is determined that the stack is valid when the latest one or more jobs with operation APPLY or DESTROY have a lifecycle-state of succeeded.

14. The method of claim 13, further comprising: downloading the stack to the publication service system; and scanning the stack for viruses.

15. The method of claim 13, further comprising receiving a request from the customer tenancy to publish the stack.

16. The method of claim 15, further comprising publishing the stack.

17. The method of claim 1, wherein the stack comprises a terraform stack.

18. A system comprising:
a memory comprising stored instructions; and
a processor configured to execute the stored instructions to:
receive at a publication service system identification of a stack for validation from a customer tenancy in a cloud computing environment, the stack having an associated stack identifier;
retrieve with the publication service system job information from the customer tenancy relevant to the stack;
determine validation status of the stack based on the retrieved job 9 information; and
designate the stack as a valid stack when it is determined that the stack is valid.

19. The system of claim 18, wherein the processor is further configured to execute the stored instructions to:
receive in the cloud computing environment policies allowing access of the customer tenancy by the publication service system;
receive a stack in the customer tenancy;
test the stack in the customer tenancy by performing a plurality of jobs; and
store job information in the customer tenancy and associated with the stack.

20. A non-transitory computer-readable storage medium storing a plurality of instructions executable by one or more processors, the plurality of instructions when executed by the one or more processors cause the one or more processors to:
receive at a publication service system identification of a stack for validation from a customer tenancy in a cloud computing environment, the stack having an associated stack 5 identifier;
retrieve with the publication service system job information from the customer tenancy relevant to the stack;
determine validation status of the stack based on the retrieved job information; and
designate the stack as a valid stack when it is determined that the stack is valid.
